(19) United States
(12) Patent Application Publication
(10) Pub. No.: US 2005/0136239 A1
(43) Pub. Date: Jun. 23, 2005

(54) Multifunctional cryo-insulation apparatus and methods

(76) Inventors: Jeffrey D. Eichinger, Fountain Valley, CA (US); Erik S. Weiser, Yorktown, VA (US); Ruth H. Pater, Yorktown, VA (US); Joel E. Slenk, Lakewood, CA (US)

Correspondence Address: BLACK LOWE & GRAHAM PLLC, 701 FIFTH AVENUE, SUITE 4800, SEATTLE, WA, 98104, US

(21) Appl. No.: 10/926,569

(22) Filed: Aug. 25, 2004

Related U.S. Application Data
(60) Provisional application No. 60/498,939, filed on Aug. 29, 2003.

(51) Int. Cl. B32B 3/26; B29C 44/12; B32B 3/12

(52) U.S. Cl. 428/304.4; 264/46.4; 428/116

(57) ABSTRACT

Apparatus and methods for multi-layer foam structures are disclosed. In one embodiment, a method includes filling a first portion of a receptacle with a removable filler. A second portion of the receptacle is filled with a first foam forming a first foam layer. The removeable filler is removed, and at least part of the first portion of the receptacle is filled with a second foam, forming a second foam layer. The first foam may include a polyimide foam, and the second foam may include a polyurethane foam. Other aspects of the invention include a skin attached to the receptacle and the first foam. In other embodiments, hexagonal honeycomb matrix may be used as a receptacle for the first foam and the second foam.

### PRIORITY CLAIM

This application claims the benefit of U.S. Provisional Patent Application No. 60/498,939 (Attorney Docket No. BING-1-1010), filed Aug. 29, 2003.

### GOVERNMENT LICENSE RIGHTS

This invention was made with Government support under U.S. Government contract, Space Launch Initiative, Contract No. NAS8-01099, awarded by the National Aeronautics and Space Administration. The U.S. Government has certain rights in this invention.

### FIELD OF THE INVENTION

This invention relates generally to foam insulation and more specifically, to foam insulation for cryo-materials tanks.

### BACKGROUND OF THE INVENTION

Typically, cryogenic propellant tanks, as in the Space Shuttle Orbiter external tank, are insulated with a light-weight (2-3 lb per cubic foot density) polymeric foam. This material, often polyurethane foam, however, is relatively weak structurally, and generally cannot endure temperatures higher than 250° F. to 300° F. Typical heat shield insulation for re-entry vehicle structures includes open celled ceramic tiles or blanket materials. These materials typically cannot be used at cryogenic temperatures because the breathable internal structure of the tiles or blankets permits air to liquify within the material, a process known as cryopumping.

Where cryogenic propellant tanks are utilized in spacecraft that leave and reenter the atmosphere, these tanks experience a very large range of temperatures near the outer surface of the tank. At the interface with the propellant, such as liquid hydrogen, the structure must endure temperatures as low as −423° F., while during re-entry the outer surface exposed to the atmosphere endures temperatures as high as 2500 degrees F. Cryogenic tanks and other equipment in other applications, from aircraft to hydrogen powered automobiles, may also be exposed to a wide range of temperatures.

Foams that can operate at higher temperatures than polyurethane foam have been tested for use as cryo-insulation on spacecraft propellant tanks. Higher operating temperature foams by way of example, but not limitation, include Rohacell foam manufactured by Rohm, and polyimide foams, including polyimide foams manufactured by Unitika, Ltd. Polyimide and Rohacell foams tolerate higher temperatures than polyurethane foams, some up to 500° F., but typically are more open-celled than polyurethane foams. Thus, when these foams are placed adjacent to cryogenic propellant tanks, the air in the open cells liquifies, and cryopumping occurs, often damaging the foam. Thus, polyurethane foams typically provide a better form of insulation than polyimide or Rohacell foams immediately adjacent to cryogenic propellant tanks because the polyurethane foams do not experience nearly as much air liquification within the foam.

The relative structural strength, however, of practically all insulating foams is somewhat limited. By way of example, this strength is typically not sufficient to permit direct bonding of a thermal protective system such as insulating ceramic tiles or blankets directly to the foam.

Alternatives to foam cryo-insulations for cryogenic tanks that will be part of a re-entry vehicle include vacuum structures. These involve a multiple wall tank with a vacuum maintained between the layers, with a re-entry thermal protective system installed to the outside layer. Alternately, structural supports may be utilized to mechanically hold the thermal protective system some distance from the outer wall of the cryogenic propellant tanks. Multiple wall tanks and structural supports for the thermal protective system typically involve greater weight than foam insulation for the same insulation values. This greater weight increases launch vehicle weight, and thus reduces the launch vehicle payload capacity. In other vehicles and cryogenic tank applications, such alternatives to foam cryo-insulations add weight and structural complexity.

Therefore, there is an unmet need to develop a cryo-insulation that can operate in a wide range of temperatures and still provide sufficient structural strength for the desired application, including, by way of example, keeping a thermal protection system, such as the ceramic tile or blanket materials, attached to its surface.

### SUMMARY OF THE INVENTION

The present invention is directed to apparatus and methods for multi-layer foam structures. In one embodiment, a method includes filling a first portion of a receptacle with a removable filler. A second portion of the receptacle is filled with a first foam forming a first foam layer. The removable filler is removed, and at least part of the first portion of the receptacle is filled with a second foam, forming a second foam layer. In accordance with other aspects of the invention, the first foam may include a polyimide foam, and the second foam may include a polyurethane foam. Other aspects of the invention include a skin attached to the receptacle and the first foam, and the use of a hexagonal honeycomb matrix as a receptacle for the first foam and the second foam.

### BRIEF DESCRIPTION OF THE DRAWINGS

The preferred and alternative embodiments of the present invention are described in detail below with reference to the following drawings.

FIG. 1A is an isometric drawing of a honeycomb hexagonal matrix utilized in an exemplary embodiment of the present invention.

FIG. 1B is a cross-section of the honeycomb hexagonal matrix of FIG. 1A.

FIG. 2 is a cross-section of the honeycomb hexagonal matrix of FIG. 1A coated with an adhesion promoter.

FIG. 3A is a cross-section of the honeycomb hexagonal matrix of FIG. 1A partially filled with removable filler.

FIG. 3B is a cross-section of the honeycomb hexagonal matrix of FIG. 1A partially filled with removable filler and polyimide foam precursor.

FIG. 3C is a cross-section of the honeycomb hexagonal matrix of FIG. 1A with a skin, ready for heat curing.

FIG. 4A is a cross-section of the honeycomb hexagonal matrix of FIG. 1A during installation of polyurethane foam.

FIG. 4B is a cross-section of an integral multi-layer foam composite structure in accordance with an embodiment of the present invention.

FIG. 5 is a flowchart of a method of forming a multi-layer foam structure in accordance with an embodiment of the present invention.

FIG. 6 is a cross section of a multi-layer foam structure installed on a space-vehicle in accordance with another embodiment of the present invention.

### DETAILED DESCRIPTION OF THE INVENTION

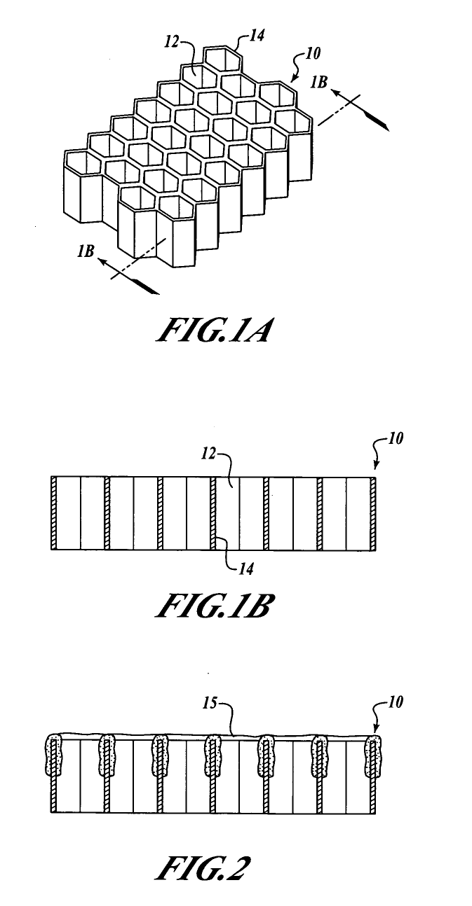

The present invention relates to apparatus and methods for multi-layer foam structures. Many specific details of certain embodiments of the invention are set forth in the following description and in FIGS. 1-6 to provide a thorough understanding of such embodiments. One skilled in the art, however, will understand that the present invention may have additional embodiments, or that the present invention may be practiced without several of the details described in the following description.

FIG. 1A is an isometric view of a hexagonal celled honeycomb structure 10 utilized as a structural foundation or matrix for an exemplary multi-layer foam structure in accordance with an embodiment of the present invention. The honeycomb 10 includes a plurality of cells 12 defined by a matrix 14. In this embodiment, the honeycomb 10 structure is a continuous sheet array of a plurality of hexagonal cells 12 of a reinforced polymeric material. The plurality of cells 12 are then filled, at least in part, with multiple layers of foam, as described below. By way of example, and not limitation, suitable honeycombs include Texas Almet, Inc., HRH 10 Aramid Fiber Reinforced Phenolic Resin, with a ⅜″ cell size, and a density of approximately 2 pounds per cubic foot. Other suitable honeycombs include HEXCEL HRP phenolic/fiberglass honeycomb manufactured of heat resistant phenolic resin, HEXCEL HRH 327 including glass fiber and polyimide resin, Kevlar honeycombs, Korex honeycombs, and metallic honeycombs.

FIG. 1B is a side cross-sectional view of the honeycomb 10 of FIG. 1A. The honeycomb 10 shown in side cross-sectional view includes cells 12, and a matrix 14. The honeycomb matrix 14 contributes structural strength to the integrally formed multi-layer foam structure.

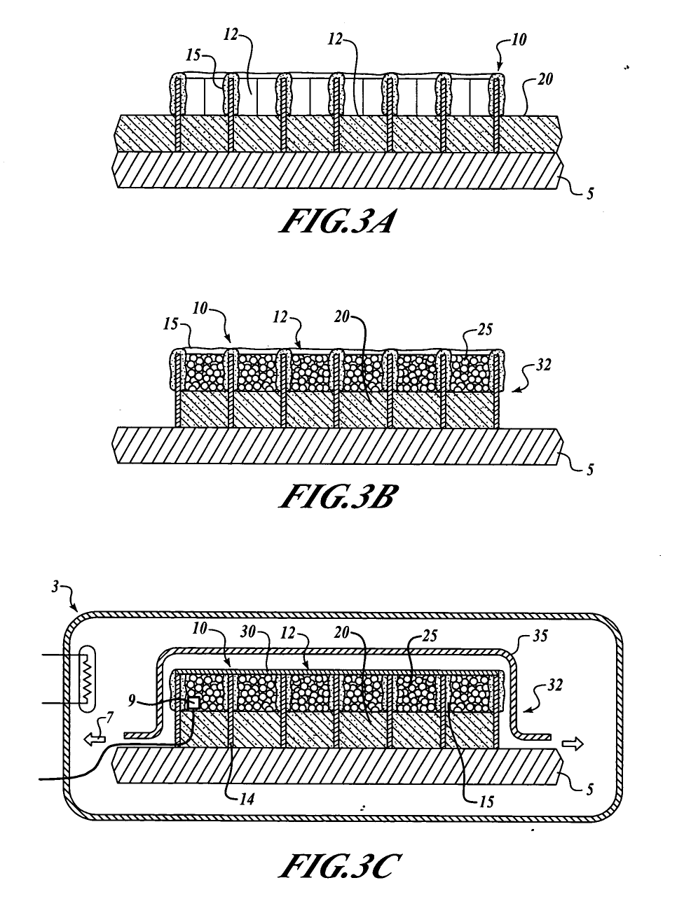

As shown in FIG. 2, in an exemplary embodiment of the present invention, the honeycomb sheet 10 may be dipped in a adhesive promoter or primer 15 to promote adhesion of one or more of the foams being installed within the honeycomb 10. By way of example, and not limitation, when polyimide foams are being utilized to partially fill the honeycomb, the adhesive promoter or primer 15 may be a polyimide adhesion promoter. In a particular embodiment, a suitable adhesive promoter 15 includes an RP50 polyimide adhesive solution reduced in methanol and NMP to 9% solids, supplied by Dr. Ruth Pater of the NASA Langley Research Center.

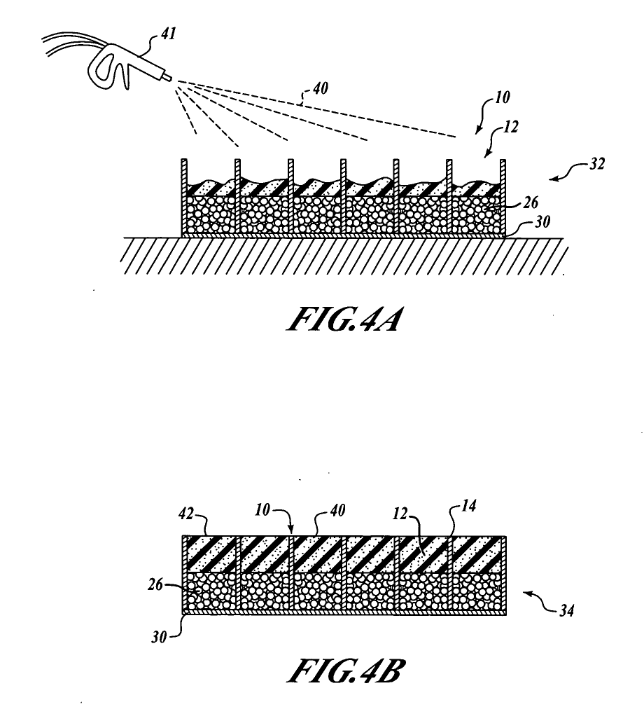

In one aspect, the primer 15 may be applied to the honeycomb 10 by first washing the honeycomb 10 in de-ionized water, and then dipping the sheet of the honeycomb 10 into a room temperature polyimide resin bath (not shown), air drying for 15-30 minutes, and then oven drying the honeycomb 10 with the adhesive promoter 15 in a circulating air oven (not shown) for one hour±10 minutes at 250° F. The honeycomb 10 is then cooled. This process substantially evaporates the solvent from the adhesive promoter 15, thus “B-staging” the resin, but preferably does not cure the polyimide. The curing of the polyimide adhesion promoter 15 may occur during the expansion and cure of a polyimide foam later installed in the honeycomb 10, as described more fully below. The polyimide adhesion promoter 15 provides adhesion between the polyimide foam (See FIG. 3B) and honeycomb 10. This enhances the durability of the insulation and eliminates gaps through which air could otherwise travel and liquify below the surface of the insulation. In FIG. 2, the primer 15 (enlarged) is shown partially coating the honeycomb 10. In this exemplary embodiment, the honeycomb 10 is dipped in a clean flat bottom tray large enough to accommodate the desired honeycomb panel size. The tray (not shown) may be filled with primer 15 to a depth equal to the desired thickness of the polyimide foam in the final composite foam structure (such as ½ the thickness of the honeycomb as shown in FIG. 2). It will be appreciated that other primers may be used for other foam types, and that at least some foams suitably adhere to the honeycomb 10 without a primer 15, depending on the foam and the desired application.

As shown in FIG. 3A, the honeycomb 10 with the coating of adhesive promoter 15 is then partially filled with a removable filler 20. In a particular embodiment, the removable filler 20 may be a silicon carbide sand. Silicon carbide sand is suitable as a removable filler due to its high thermal conductivity. This provides good heat distribution during cure of the polyimide foam layer, as described below. Depending upon the heat and other characteristics desired for the removable filler 20, other sands or fillers may be utilized, including, for example, aluminum oxide sand. By way of example and not limitation, a suitable silicon carbide sand is Silicon Carbide 120-450 mesh, 220 grit, McMaster Carr Part No.3441k84.

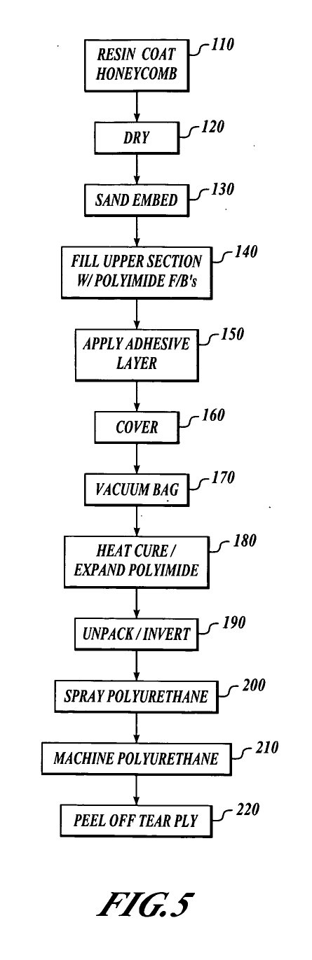

In one embodiment, the removable filler 20 may be placed within the cells 12 of the honeycomb 10 by covering a mold or base 5 with a layer of silicon carbide sand. The silicon carbide sand filler 20 may be leveled to the desired thickness of a second foam 40 (See FIG. 4B) which is to be installed in the finished insulation panel. It will be appreciated that the portion of the honeycomb 10 or foam receptacle filled with the a second foam 40 (See FIG. 4B), and thus filled with filler 20 at this stage, may be any portion of the honeycomb 10, from a very small portion to a very large portion, including from 1% to 99% of the honeycomb 10, depending on the desired features of the final multi-layer foam structure.

By way of example, and not limitation, the second foam 40 (See FIG. 4B) may be a polyurethane foam, as described more fully below. The coated honeycomb 10 is placed onto the filler 20, pressed into the filler 20, covered with a caul plate (not shown), and tapped with a rubber mallet until it is seated in the mold with the filler 20 partially filling the cells 12. This leaves a lower portion of the cells 12 filled with filler 20. The balance of the cells 12 above the filler 20 may then be filled with a foam precursor 25. In an example embodiment, the portion of the honeycomb 10 without promoter 15 is the portion placed into the filler 20, because for some promoters 15, filler 20 can interfere with binding of the promoter 15 to later added foam.

In FIG. 3B, the honeycomb 10, coated with primer 15, is shown with its cells 12 filled with the filler 20 (lower portion of cells 12) and a foam precursor 25 (upper portion of cells 12). In a particular embodiment, the precursor 25 may suitably be a polyimide foam precursor. Polyimide foams typically endure higher thermal operating temperatures than polyurethane foams. In the present invention, the polyimide layer of foam precursor 25 is typically the foam layer furthest from the cryogenic propellant tank when the multi-layer foam insulating structure is applied to a cryogenic propellant tank. In one particular aspect, the polyimide foam precursor 25 may be polyimide friable balloons manufactured by Unitika, Ltd., as described in part in U.S. Pat. Nos. 6,133,330, and 6,180,746. Such polyimide foams suitably include, for example, TEEK-H Polyimide Friable Balloons manufactured by Unitika Ltd, of Kyoto Japan.

As further shown in FIG. 3B, friable balloons of the foam precursor 25 have been leveled to the upper surface of the honeycomb 10. The polyimide foam precursor 25 after cure offers a service temperature of 500 degrees F., which is 100 degrees higher than Rohacell foam, and 250 degrees higher than alternate polyurethane foams. Having a higher operating temperature foam installed immediately below the thermal protective system on a space vehicle may advantageously permit the thermal protective system to be thinner, and thus lighter. Put differently, higher operating temperatures at the boundary between a thermal protective system and the cryo-insulation resulting from a thinner thermal protection system are accommodated by the higher operating temperature of the polyimide foam. It will be appreciated that in other applications, such as those in vehicles, aircraft, or fixed equipment that incorporate cryogenic tanks or other equipment involving cooling, heating, or wide temperature differentials, the use of differing temperature accommodating foam composites, with a structural support, may be desirable.

It will also be appreciated that a first foam layer may also be installed in the honeycomb 10 by means other than filling with a precursor 25 and curing, such as spraying and machining away any excess foam. It will also be appreciated that a mold release may be desirable between the base 5 or other mold, and the precursor 25 filled honeycomb 10. By way of example, suitable mold releases for polyimide foam precursors include Frekote 33.

In an exemplary embodiment of the present invention, a skin 30 may be added to the honeycomb 10 and the polyimide foam layer 25, as shown in FIG. 3C. By way of example, but not limitation, the skin 30 may be placed over the upper surface of the honeycomb sheet 10 and the precursor 25 after filling the cells 12 of the honeycomb 10 with the precursor 25. In one embodiment, the skin 30 bonds to the edges of the matrix 14 of the honeycomb 10, as well as to the polyimide foam formed during heating when the polyimide precursor 25 is cured. The skin 30 may be formed of any suitable material, including, for example, a bismaleimide (BMI) film adhesive such as a 2550G film adhesive commercially-available from Cytec. The BMI film may be heat cured and bonded to the cell walls 14 of the honeycomb 10. When the assemblage of the skin 30, honeycomb 10, and the precursor 25 is heat cured, the BMI film adhesive skin 30 suitably bonds to the matrix 14 of the honeycomb 10 before the precursor 25 foams and expands. As the BMI film 30 is heat cured and bonded to the honeycomb 10, it softens. Under pressure, the film 30 may form fillets at the junctures with the edges of the matrix 14 of the honeycomb 10. These fillets (not shown) advantageously increase the strength of the bond of the skin 30 to the matrix 14 of the honeycomb 10. It should be noted that such fillets typically do not form when a skin is bonded to a honeycomb that has already been filled with expanded foam. In that case, expanded foam already fills the honeycomb to the upper edges of the matrix 14, leaving no space for filleting of the skin 30 against the matrix 14. Traditionally it has been difficult to bond to foam-filled honeycomb because the previously installed foam prevents filleting thereby reducing the bond strength between the skin 30 and the honeycomb 10.

Filleting helps to optimize the strength of the bond of the skin 30 to the honeycomb 10 matrix 14. In the method of the present invention, because the first foam at this stage is a polyimide foam precursor 25 in the form of friable balloons that have not expanded at the time the adhesive skin 30 bonds to the matrix 14, the precursor 25 does not impede the filleting of the adhesive skin 30.

The skin 30 suitably may be held in position in the assemblage 32 by any suitable method during heat bonding of the skin 30, and the heat curing of the precursor 25. By way of example, but not limitation, as shown in FIG. 3C, the assemblage 5 is inserted into an autoclave 3 for heat curing of the skin 30 and heat curing of the polyimide foam precursor 25. The assemblage may be held together during cure by a suitable securing mechanism or clamp, including, for example, a vacuum bag 35. In operation, when air 7 is evacuated from the vacuum bag 35, the vacuum bag 35 collapses and holds the honeycomb 10 (in this example half filled with filler 20 and half filled with precursor 25 and covered with the covering skin 30) firmly on to the base 5. It will be appreciated that a caul plate or other suitable weight or securing mechanism may be utilized to hold the assemblage 32 in position during transport and/or curing.

During cure, the autoclave may be maintained under 45 psi of autoclave pressure and the vacuum bag 35 may be vented to the atmosphere, with the result that pressure is maintained on the honeycomb 10, precursor 25 and skin 30 during heat curing. By way of example and not limitation, at least one thermocouple 9 is typically installed in the polyimide foam 25 to monitor the temperature of the foam 25 during the cure process.

The assemblage 32 on the base 5 may then run through a multi-step heat cure process in the autoclave 3. In one embodiment, a suitable heat curing process includes heating the assemblage 32 at a rate of 4 to 6° F. per minute to a temperature of about 375°±10° F. The assemblage 32 may then dwell at the elevated temperature for approximately 60 minutes±5 minutes. The assemblage 32 may then be heated at a rate of 4 to 6° F. per minute to roughly 482°±5° F. The assemblage 32 may again dwell at this elevated temperature for approximately 120 minutes±5 minutes. The assemblage 32 may then be heated again at rate of 1±0.9° F. to a temperature of about 550°±5° F. The assemblage 32 may again dwell at this elevated temperature for roughly 60 minutes±5 minutes. The assemblage 32 suitably may then be cooled at a rate of 5±3° F. per minute to below approximately 250° F. prior to removing from the mold or base 5.

Control temperature may be suitably based on the average temperature of two thermocouples 9 in the precursor 25 at opposite edges of the honeycomb panel 10, each located ¼ to ½ inch from the panel edge. In a particular aspect, the maximum difference between the autoclave air temperature and the assemblage 32 temperature may be limited to 375° F., and the maximum air temperature during cure may be prevented from exceeding about 575° F.

The above-described heat cure process may result in the skin 30 bonding to the matrix 14 of the honeycomb 10. The polyimide foam precursor 25 then expands and cures, bonding to the matrix 14 with the assistance of the primer 15 previously applied to the honeycomb 10. As the polyimide foam precursor 25 cures, it may also bond to the BMI film skin 30 as these two materials adhere to each other on curing.

With continued reference to FIG. 3C, after heat curing, the assemblage 32 is removed from the autoclave 3, and the vacuum bag 35 is removed. The honeycomb 10 with the now cured polyimide foam and attached skin 30 is removed from the filler 20 and inverted. As shown in FIG. 4A, the resulting assembly 32 includes the honeycomb 10 with its cells 12 partially filled with cured polyimide foam 26. The BMI skin 30 is attached to the polyimide foam 26 and the honeycomb 10. It will be appreciated that removing the assemblage 32 from the sand and inverting it leaves a portion of the plurality of honeycomb cells 12 empty and open to be filled with a layer of second foam 40.

In a preferred embodiment, the second foam 40 is a polyurethane foam layer. Specifically, with the assemblage 32 inverted, placing the skin 30 down, a remaining portion of the plurality of cells 12 of the honeycomb 10 may be filled with sprayed second foam 40, sprayed from a spray polyurethane gun 41. By way of example but not limitation, the second foam 40 may be sprayed on to the honeycomb 10 until an upper portion of the cells 12 of the honeycomb 10 are completely filled. In an exemplary embodiment, as the second foam 40 cures, it suitably self-adheres to the honeycomb 10 and the cured polyimide foam 26 without further steps or materials. The second foam 40 may expand and overfill the honeycomb 10. The second foam 40 suitably may include polyurethane foam by Polymer Development Laboratories, Inc., product numbers 1034-2.5 and 1034-141. Other foams that may be utilized for the second foam 40, include, by way of example, but not limitation, polyisocyanurate foam

Any second foam 40 overfill (not shown) may be machined off to the upper edge of the honeycomb 10 using a mill, a drill press fitted with a diamond grinder, or any other suitable removal process.

In a preferred aspect, the second foam 40 is a polyurethane foam sufficiently closed-celled to minimize or eliminate cryo-pumping when the second foam 40 is installed against a cryogenic propellant tank. Thus, in a particular embodiment of the present invention, the resulting exemplary structure 34 is a two-layer foam-filled honeycomb-matrix-core cryogenic insulation consisting of polyimide and polyurethane foams in an aramid/phenolic honeycomb.

It should be noted that the skin (or BMI adhesive film) 30 may suitably include a removable tear ply (not shown) on its outside surface, i.e. the side away from the honeycomb 10 and the polyimide foam 26. Thus, when the multi-layer foam structure 34 is completed, and ready to be installed, the tear ply over the BMI film may be torn off. In this exemplary embodiment, the removal of the tear ply layer exposes a fresh surface for adhering a thermal protective system, or other structure or attachment to the skin 30. By way of example, but not limitation, the tear ply may suitably be a sheet that may be laid against the BMI film skin 30 prior to cure, such as a teflon coated fiberglass release ply 200PFP-1 manufactured by Richmond Aircraft Products.

As further shown in FIG. 4B, an exemplary integral multi-layer foam composite structure 34 of the present invention thus includes a skin 30 bonded to a honeycomb 10, with the cells 12 of the honeycomb 10 half filled with cured polyimide foam 26, and half filled with polyurethane second foam 40. The skin 30 is suitably installed on the side of the honeycomb 12 adjacent to the cured polyimide foam 26, in this exemplary embodiment.

The resulting structure 34 may be bonded to a cryogenic propellant tank. The structure 34 is bonded to the tank (not shown) with the side of the honeycomb 10 filled with polyurethane second foam 40 bonded towards the tank. This insulates the tank with the desired more closed-cell polyurethane second foam 40 closest to the tank, and higher temperature tolerant, but more open-celled polyimide foam 26 spaced away from the tank where the polyimide foam 26 is not subject to cryo-pumping. A significant portion of the internal structural strength of the multi-layer foam assemblage 34 is provided by the honeycomb 10, permitting the assemblage to carry loads such as aerodynamic loads, or to be attached to other equipment. A thermal protective system, such as ceramic tiles or a ceramic blanket may be attached to the structure 34 by adhering it to the skin 30, or if no skin is desired, to the honeycomb 10. The thermal protective system is thus suitably secured against aerodynamic loads, because the skin 30 is cured and bonded to the polyimide foam 26 and the cell walls 14 of the honeycomb 10, which provides sufficient structural strength to bear the loads. It will be appreciated that in alternate embodiments, a skin 30 may be applied to none, one or both sides of the honeycomb 10.

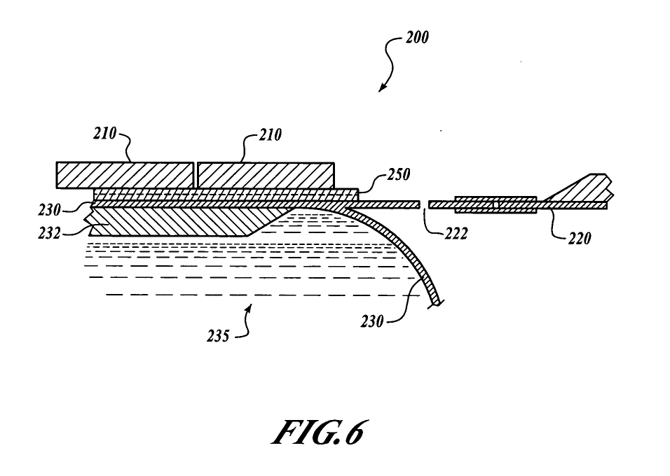

An exemplary method of manufacturing the multi-layer foam structure of the present invention is outlined in a flow chart in FIG. 5. The method includes priming or resin coating a honeycomb at a block 110, and drying the honeycomb at a block 120. The honeycomb is partially embedded in a removable filler, in this example a sand embed, at a block 130. Filling of an upper section of the honeycomb with polyimide friable balloons occurs at a block 140. A BMI adhesive layer or skin may be applied, as desired, at a block 150. The resulting resin coated honeycomb assemblage, partially embedded in the removable filler, with its upper section filled with polyimide friable balloons and covered with adhesive skin, is covered and vacuum bagged at blocks 160 and 170 respectively. The assemblage is, bonded, heat cured and the polyimide foam is expanded at a block 180. The assemblage is unpacked and inverted at a block 190, including removing the removable filler. At a block 200, the inverted assemblage is sprayed with polyurethane foam. At a block 210, the excess polyurethane is removed (e.g. by machining or other suitable process). As desired, if a tear ply was previously applied to the adhesive skin, that tear ply may be peeled off at a block 220, preparing a fresh surface of the final multi-layer foam structure to adhere to another layer or other equipment, such as a thermal protective system for a spacecraft.

It will be appreciated that the structure and method of the present invention may be utilized with a variety of foam materials and different support structures and materials. For example, in alternate embodiments, the hexagonal cells 12 of the honeycomb panel 10 may be replaced with square, rectangular, circular, or any other suitably shaped cells. It will also be appreciated that the structure and the method of the present invention is not limited in applicability to cryogenic propellant tanks of space vehicles, but may be utilized in any application where a combination of insulating and structural features are desired. The structure and method of the present invention thus provide a means for a strong system that can combine the desirable features of at least two different types of foam insulation into an integral, easy to install package.

FIG. 6 is a cross-section of a section of a exemplary aerospace vehicle 200 incorporating an exemplary multi-layer foam structure 250 in accordance with an embodiment of the present invention. The aerospace vehicle has a tank wall 230 holding cryogenic propellant 235. The tank wall 230 is internally reinforced by stringers 232. The tank is connected to a lower stage through an intertank 220, which is vented with an intertank purge 222. In this example, the intertank 220 is not insulated with cryo-insulation. The outer surface of the tank wall 230 is covered with an exemplary multi-layer foam structure 250 in accordance with an embodiment of the present invention. The foam structure 250 is bonded to the tank wall 230 with adhesive (not shown). Attached over the foam structure 250, on the side away from the tank wall 230, is a thermal protection system 210, in this example ceramic tiles. The thermal protection system 210 may be bonded direct to the foam structure 250 with adhesive (not shown), as shown in this example embodiment, or alternately, may be bonded to a skin (not shown) incorporated in the foam structure 250, in the manner described above. The foam structure 250 may thus provide a lightweight cryogenic tank insulation, with increased heat tolerance towards the thermal protection system 210, and resistance to cryo-pumping next to the tank wall 230.

It may be appreciated that the aerospace vehicle 200 may be any model or type of vehicle that includes a tank for carrying cryogenic materials, including, for example, a planetary probe, a satellite or other type of spacecraft, a conventional or hypersonic aircraft, or a reusable orbital vehicle. In further embodiments, the vehicle 200 may be any type of land, sea, or undersea vehicle that is capable of transporting cryogenic materials, including automobiles, trains, ships, submarines, or any other suitable vehicle type.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for creating a multilayer foam structure, the method comprising:
filling a first portion of a receptacle with a removable filler;
filling a second portion of the receptacle adjacent to the first portion with a first foam to form a first layer;
removing at least some of the removable filler; and
filling at least some of the first portion of the receptacle with a second foam forming a second foam layer proximate to the first layer.

2. The method of claim 1, further comprising coating the at least some of the receptacle with a primer.

3. The method of claim 2, wherein the primer includes an adhesion promoter.

4. The method of claim 3, wherein the adhesion promoter includes a polyimide resin.

5. The method of claim 2, wherein coating the at least some of the receptacle with a primer includes heat drying the primer.

6. The method of claim 1, wherein at least one of the first and second foams include a polyimide foam.

7. The method of claim 1, wherein filling the second portion includes filling the second portion with a polyimide foam precursor and curing the polyimide foam precursor.

8. The method of claim 7, wherein curing the polyimide foam precurser includes heat curing the polyimide foam precurser.

9. The method of claim 8, wherein heat curing the polyimide foam precurser includes heating the polyimide foam precurser in stages.

10. The method of claim 9, wherein heating the polyimide foam precurser in stages includes heating the polyimide foam precurser to at least one of a first stage within a first range of approximately 375°±10° F., a second stage within a second range of approximately 482°±5° F., and a third stage within a third range of approximately 550°±5° F.

11. The method of claim 9, wherein heating the polyimide foam precurser in stages includes heating the polyimide foam precurser to a first stage within a first range of approximately 375°±10° F. for approximately 60 minutes±5 minutes, to a second stage within a second range of approximately 482°±5° F. for approximately 120 minutes±5 minutes, to a third stage within a third range of approximately 550°±5° F. for approximately 60 minutes±5 minutes.

12. The method of claim 1, wherein the second foam includes a polyurethane foam.

13. The method of claim 12, wherein filling the first portion includes spraying the polyurethane foam.

14. The method of claim 1, wherein the removable filler includes sand.

15. The method of claim 14, wherein the sand includes silicon carbide sand.

16. The method of claim 1, wherein the receptacle includes a support structure.

17. The method of claim 16, wherein the support structure includes a contiguous array of hexagonal cells.

18. The method of claim 1, further comprising attaching a skin to the receptacle and at least one of the first and second foams.

19. The method of claim 18 wherein the skin includes a bismaleimide sheet.

20. The method of claim 19 wherein attaching the skin to the receptacle and at least one of the first and second foams occurs before expansion and cure of the at least one of the first and second foams.

21. The method of claim 1 wherein the first layer is adjacent to the second layer.

22. A multilayer structure, comprising:
a receptacle adapted to receive a plurality of layers of foam;
a first foam partially filling the receptacle and forming a first foam layer, the first foam configured to adhere to the receptacle; and
a second foam partially filling the receptacle proximate to the first foam layer, forming a second foam layer, the second foam configured to adhere to the first foam and to the receptacle.

23. The structure of claim 22, wherein at least some of the receptacle is coated with a primer.

24. The structure of claim 23, wherein the primer includes a polyimide adhesion promoter.

25. The structure of claim 24, wherein at least one of the first and second foams includes a polyimide foam.

26. The structure of claim 22, wherein at least one of the first and second foams includes a polyurethane foam.

27. The structure of claim 22, wherein the receptacle includes a honeycomb structure.

28. The structure of claim 27, wherein the honeycomb structure includes a contiguous sheet array of hexagonal cells.

29. The structure of claim 22, further comprising a skin, the skin arranged to cover and bond to the receptacle and to the first foam.

30. The structure of claim 29, wherein the skin includes a bismaleimide sheet.

31. The structure of claim 29, wherein the skin includes a tear off ply.

32. A method of forming a structure, the method comprising:
coating at least part of a receptacle having a plurality of cells with an adhesion promoter;
filling a first portion of the plurality of cells with a first layer of a removable filler;
forming a layer of polyimide foam within a second portion of the plurality of cells adjacent to the removable filler;
removing the removable filler; and
after removing the removable filler, forming a layer of polyurethane foam within the first portion of the plurality of cells adjacent to the polyimide foam.

33. The method of claim 32, wherein forming a layer of polyimide foam includes at least partially filling the second portion with a polyimide foam precursor and curing the polyimide foam precursor.

34. The method of claim 33, wherein at least partially filling the second portion with a polyimide foam precursor includes at least partially filling the second portion with a polyimide foam friable balloons precursor.

35. The method of claim 34, wherein forming a layer of polyurethane foam includes spraying the polyurethane foam.

36. The method of claim 32 wherein filling the first portion includes removing excess polyurethane foam.

37. The method of claim 32, wherein the removable filler includes sand.

38. The method of claim 37, wherein the sand includes silicon carbide sand.

39. The method of claim 32, wherein the receptacle includes a honeycomb structure.

40. The method of claim 39 wherein the honeycomb structure includes a contiguous sheet array of hexagonal cells.

41. The method of claim 32, wherein coating the receptacle includes dipping the receptacle in the polyimide adhesion promoter.

42. The method of claim 41, wherein coating the receptacle includes drying the polyimide adhesion promoter.

43. The method of claim 32, further comprising adhering a skin to the receptacle and the polyimide foam.

44. The method of claim 43, wherein adhering a skin includes heat bonding a bismaleimide skin to the receptacle.

45. The method of claim 32, further comprising tearing off a tear ply from the skin.

46. A foam structure, comprising:
a support member having a plurality of cells adapted to receive a plurality of layers of foam;
a polyimide foam layer disposed within the plurality of cells, the polyimide foam layer being adhered to the receptacle; and
a polyurethane foam layer disposed within the plurality of cells and being adhered to the first foam and to the receptacle.

47. The structure of claim 46, wherein the support member is at least partially coated with a polyimide adhesion promoter.

48. The structure of claim 46, wherein the support member includes a honeycomb structure having a contiguous array of hexagonal cells.

49. The structure of claim 46, further comprising a skin including bismaleimide, adhered to the receptacle and the polyimide foam.

50. The structure of claim 49, wherein the skin includes a tear off ply.

51. A vehicle, comprising:
a tank adapted to hold a cryogenic material;
a support member attached to the tank, the support member including a plurality of cells adapted to receive a plurality of layers of foam;
a first foam layer partially filling the plurality of cells and being adhered to the support member; and
a second foam layer partially filling the plurality of cells, the second foam layer being adhered to the first foam layer and to the support member.

52. The vehicle of claim 51 wherein the at least some of the support member is coated with a primer.

53. The vehicle of claim 52 wherein the primer includes a polyimide adhesion promoter.

54. The vehicle of claim 51 wherein at least one of the first and second foam includes a polyimide foam.

55. The vehicle of claim 51 wherein at least one of the first and second foam includes a polyurethane foam.

56. The vehicle of claim 51 wherein the support member includes a honeycomb structure.

57. The vehicle of claim 56 wherein the honeycomb structure includes a contiguous sheet array of hexagonal cells.

58. The vehicle of claim 51 further comprising a skin bonded to the receptacle and to the first foam layer.

59. The vehicle of claim 58, wherein the skin includes a bismaleimide sheet.

60. The vehicle of claim 59, wherein the skin includes a surface created by removing a tear off ply.
